(19) United States
(12) Patent Application Publication
(10) Pub. No.: US 2015/0148478 A1
(43) Pub. Date: May 28, 2015

(54) Renewable Non-Carcinogenic Bio Oil-Derived Residue Compositions, and Methods of Making and Using

(71) Applicant: KiOR, Inc., Pasadena, TX (US)

(72) Inventors: Jeffrey C. Trewella, Kennett Square, PA (US); Vicente Sanchez, Houston, TX (US)

(73) Assignee: KiOR, Inc., Pasadena, TX (US)

(21) Appl. No.: 14/088,964

(22) Filed: Nov. 25, 2013

(51) Int. Cl. C08K 5/01; C08K 3/36; C08K 3/04

(52) U.S. Cl. CPC C08K 5/01; C08K 3/04; C08K 3/36
USPC 524/574; 252/364; 524/575

(57) ABSTRACT

Disclosed are substantially non-carcinogenic bio oil-derived residue compositions produced from the pyrolysis or thermo catalytic conversion of biomass, and their use as solvents in the production of tires.

### FIELD OF THE INVENTION

The presently disclosed and claimed inventive process(es), procedure(s), method(s), product(s), result(s) and/or concept(s) (collectively hereinafter referenced to as the “presently disclosed and claimed inventive concept(s)”) relates generally to the use of heavy hydrocarbons containing polycyclic aromatic compounds as solvents in the production of tires, and more particularly, to the production and use of substantially non-carcinogenic biooil-derived residue compositions produced from the thermo catalytic conversion of biomass for use as solvents in the production of tires.

### DESCRIPTION OF THE RELATED ART

With the rising costs and environmental concerns associated with fossil fuels, renewable energy sources have become increasingly important, and in particular, the production of renewable transportation fuels from the conversion of biomass feedstocks. Many different processes have been, and are being, explored for the conversion of biomass to biofuels and/or specialty chemicals. Some of the existing biomass conversion processes include, for example, combustion, gasification, slow pyrolysis, fast pyrolysis, liquefaction, and enzymatic conversion. The conversion products produced from these processes tend to be of low quality, containing high amounts of water and highly oxygenated hydrocarbonaceous compounds, making them difficult to separate into aqueous and bio-oil phases. Also, these products usually require extensive secondary upgrading in order to be useful as transportation fuels.

Bio-oils produced from the thermo-catalytic conversion of biomass tend to be of better quality, with hydrocarbonaceous compounds having relatively low oxygen content, and which are generally separable by gravity separation into aqueous and hydrocarbonaceous phases.

In addition to containing fuel range fractions, such bio-oils, after hydrotreatment, also contain bio oil-derived residues boiling at 650 F and higher and comprising aromatic hydrocarbons (often in amounts greater than 70 wt. %).

Typical petroleum-derived oils boiling in this range contain polycyclic aromatic compounds and are carcinogenic. Such petroleum-derived aromatic oils have a relatively low viscosity index (VI typically <90), and are thus undesirable in lubrication basestocks. Because of this, these materials are typically subjected to solvent refining/extraction (using solvents such as furfural or N-methylpyrrolidone, and the like) to produce high VI light neutral and heavy neutral raffinates that can be further processed into lubrication basestocks. The produced byproduct extracts boil between 650-1000 F, contain >60 wt % aromatics, and are commonly referred to as distillate aromatic extracts (DAE's). Because of their excellent solvency, DAE's are combined with polymers (such as styrene-butadiene resin, ethylene propylene diene monomer, and the like), fillers (such as carbon black, silica, and the like), and additives (such as antioxidants, antiozonants, and the like) to produce tire compounds.

The major carcinogens in aromatic containing streams, such as DAE's, are certain polycyclic aromatic compounds (PAC). The European Commission mandates that method IP 346 be used as the basis for labeling certain refinery streams for carcinogenicity, and streams having PAC contents greater than 3 wt. % require labeling as carcinogenic. Most DAE's have IP 346 values that exceed the 3 wt. % standard and must be labeled as carcinogenic.

At the molecular level, DNA mutations are the result of intercalation of certain PAC oxidation metabolites into the DNA double helix structure. Specifically, the troublesome metabolites are those PAC that can form bay region diol epoxides. PAC like phenanthrene, chrysene, and benzo[1]pyrene have bay regions. As shown below, phenanthrene's bay region is between carbons 4 and 5.

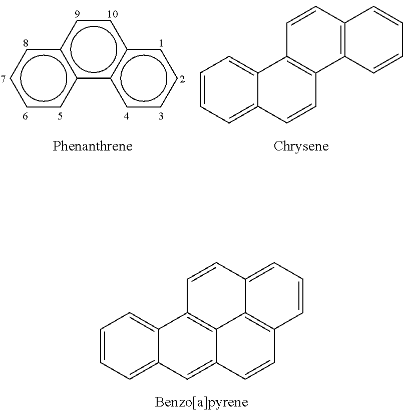

In contrast, PAC like anthracene and pyrene have no bay regions and therefore do not contribute significantly to mutations.

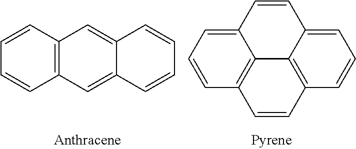

The following scheme illustrates the metabolic pathway leading to the formation of a mutagen, in this case benzo[a]pyrene bay region diol epoxide, which is shown intercalating in DNA to bond covalently to the nucleophilic guanine base at the N2 position. This leads to mutations, that is, a misreading of the DNA-encoded amino acid sequence for constructing the target protein.

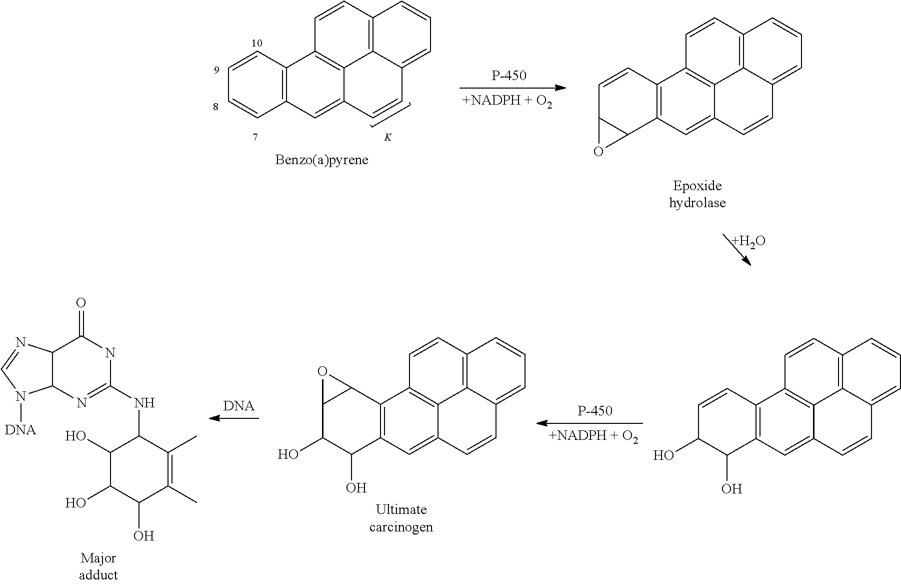

Also, there is a strong correlation (R=0.93, n=132) between the gross compositional measure of weight percent of 3 to 7 ring PAC content and the Mutagenicity Index (“MI”), as illustrated in FIG. 1, which is the “FIG. 1” reproduced from the publication by T. A. Roy, G. R. Blackburn and C. R. Mackerer, “Evaluation of Analytical Endpoints to Predict Carcinogenic Potency of Mineral Oils”, in: The Proceedings of the 14^{th} International Symposium on Polycyclic Aromatic Compounds, Lake of the Ozarks, Mo., September 1993. Published in: Polycyclic Aromatic Compounds, Volume 5, 279 (1994); which is incorporated by reference herein in its entirety.

Accordingly, there remains a need for a solvent material to replace petroleum-derived DAE's which is less carcinogenic (having lower concentrations of PAC including un-hindered bay regions), such as the bio oil-derived residue compositions of the presently disclosed and claimed inventive concept(s) which have IP 346 values less than 3 wt. %.

### SUMMARY OF THE INVENTION

In accordance with an embodiment of the presently disclosed and claimed inventive concept(s), there is provided a bio oil-derived residue composition having an initial boiling point of at least about 650° F., and comprising at least about 70 wt. % aromatic hydrocarbons, wherein the aromatic hydrocarbons comprise polycyclic aromatic compounds, and wherein the bio oil-derived residue composition comprises less than about 3 wt. % of the polycyclic aromatic compounds containing at least 4 rings.

In accordance with another embodiment, less than about 1 wt. % of the polycyclic aromatic compounds of the bio oil-derived residue composition comprise an unsubstituted bay region which can form a bay region diol epoxide.

In accordance with another embodiment, the bio oil-derived residue composition has a mutagenicity index (MI), as measured by the Modified Ames Test (ASTM E1687), of less than about 3.0.

In accordance with another embodiment, the bio oil-derived residue composition has a dimethyl sulfoxide extract weight, as measured by IP346, of less than about 3 wt. %.

In accordance with another embodiment, a process for producing the bio oil-derived residue composition is provided and comprises:
a) converting biomass in a conversion reactor containing a heat transfer media, which can optionally comprise a catalyst, to thereby produce a conversion reactor effluent comprising vapor conversion products;
b) condensing at least a portion of the vapor conversion products to produce a condensate comprising bio-oil and water, wherein the bio-oil has a total organic oxygen content of less than about 40 wt. %;
c) hydrotreating the bio-oil with hydrogen in a hydrotreater reactor to produce a hydrotreater reactor effluent;
d) separating a total liquid product having less than 3 wt % oxygen from the hydrotreater reactor effluent; and
e) separating the bio oil-derived residue composition, having an initial boiling point of at least about 650° F., from the total liquid product.

In accordance with another embodiment, there is provided a tire compound comprising:
i) a bio oil-derived residue composition having an initial boiling point of at least about 650° F., and comprising at least about 70 wt. % aromatic hydrocarbons, wherein the aromatic hydrocarbons comprise polycyclic aromatic compounds, and wherein the bio oil-derived residue composition comprises less than about 3 wt. % of the polycyclic aromatic compounds containing at least 4 rings;
ii) a polymer; and
iii) a filler.

### BRIEF DESCRIPTION OF THE FIGURES

FIG. 1 is a plot of Mutagenicity Index vs. 3-7 Ring PAC Content and is reproduced from the publication by T. A. Roy, G. R. Blackburn and C. R. Mackerer, “Evaluation of Analytical Endpoints to Predict Carcinogenic Potency of Mineral Oils”, in: The Proceedings of the 14^{th} International Symposium on Polycyclic Aromatic Compounds, Lake of the Ozarks, Mo., September 1993. Published in: Polycyclic Aromatic Compounds, Volume 5, 279 (1994).

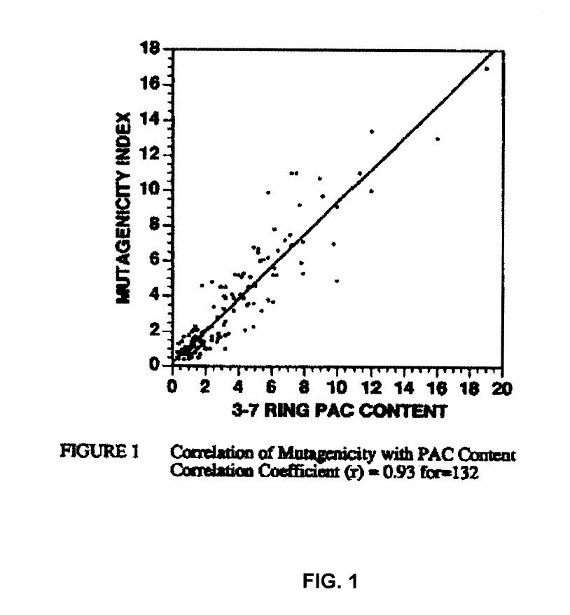

### DETAILED DESCRIPTION OF THE INVENTION

Before explaining at least one embodiment of the presently disclosed and claimed inventive concept(s) herein in detail, it is to be understood that the presently disclosed and claimed inventive concept(s) is not limited in its application to the details of construction and the arrangement of the components or steps or methodologies set forth in the following description or illustrated in the drawings. The presently disclosed and claimed inventive concept(s) herein are capable of other embodiments or of being practiced or carried out in various ways. Also, it is to be understood that the phraseology and terminology employed herein is for the purpose of description and should not be regarded as limiting the presently disclosed and claimed inventive concept(s) herein in any way. All terms used herein are intended to have their ordinary meaning unless otherwise provided.

The presently disclosed and claimed inventive concept(s) relate to the use of bio oil-derived residue composition(s) as a non-carcinogenic solvent, particularly as a component of a tire compound. As used herein, “bio oil-derived residue” refers to a distillation bottoms bio oil-derived from the thermal or thermo-catalytic conversion of biomass, as further described below.

Pyrolysis as used herein refers to non-catalytic pyrolysis processes. Fast pyrolysis processes are pyrolysis processes for converting all or part of the biomass to bio-oil by heating the biomass in an oxygen-poor or oxygen-free atmosphere. The biomass is heated to pyrolysis temperature for a short time compared with conventional pyrolysis processes, i.e. less than 10 seconds. Pyrolysis temperatures can be in the range of from about 200° C. to about 1000° C. Often the biomass will be heated in a reactor using an inert heat carrier, such as sand. As used above, the term “oxygen-poor” refers to an atmosphere containing less oxygen than ambient air. In general, the amount of oxygen should be such as to avoid combustion of the biomass material, or vaporized and gaseous products emanating from the biomass material, at the pyrolysis temperature. Preferably the atmosphere is essentially oxygen-free, that is, contains less than about 1 weight percent oxygen.

Biomass thermo-catalytic conversion as used herein refers to a catalytic pyrolysis, wherein a catalyst is used to help facilitate conversion of the biomass under fast pyrolysis type conditions. Accordingly, in a biomass thermo-catalytic conversion process a catalyst is used in the reactor to facilitate the conversion of the biomass to bio oil. The catalyst can be pre-mixed with the biomass before introduction into the reactor or be introduced into the reactor separately. If introduced separately into the reactor a particulate catalyst can be used in place of all or part of the inert heat carrier. The catalyst can be a heterogeneous acid catalyst, such as an alumino-silicate.

The biomass material useful in the invention described herein can be any biomass capable of being converted to liquid and gaseous hydrocarbons.

Preferred are solid biomass materials comprising a cellulosic material, in particular lignocellulosic materials, because of the abundant availability of such materials, and their low cost. The solid biomass feed can comprise components selected from the group consisting of lignin, cellulose, hemicelluloses, and combinations thereof. Examples of suitable solid biomass materials include forestry wastes, such as wood chips and saw dust; agricultural waste, such as straw, corn stover, sugar cane bagasse, municipal waste, in particular yard waste, paper, and card board; energy crops such as switch grass, coppice, eucalyptus; and aquatic materials such as algae; and the like.

Particularly, the bio oil-derived residue composition(s) can be prepared by a process comprising, consisting of, or consisting essentially of:
a) converting biomass in a conversion reactor containing a heat transfer media to thereby produce a conversion reactor effluent comprising, consisting of, or consisting essentially of vapor conversion products;
b) condensing at least a portion of the vapor conversion products to produce a condensate comprising, consisting of, or consisting essentially of bio-oil and water, wherein the bio-oil has a total organic oxygen content of less than about 40 wt. %;
c) hydrotreating the bio-oil with hydrogen in a hydrotreater reactor to produce a hydrotreater reactor effluent;
d) separating a total liquid product having less than about 3, or less than about 2, or less than about 1 wt % organic oxygen from the hydrotreater reactor effluent, and
e) separating the bio oil-derived residue composition(s) having an initial boiling point of at least about 650 of from the total liquid product by conventional distillation.

In another embodiment, the heat transfer media can optionally comprise a catalyst. When the heat transfer media does not comprise, or is substantially absent of, a catalyst (such as in a biomass pyrolysis process), the bio-oil has a total organic oxygen content of from about 25 wt. % to less than about 40 wt. %. In addition, the condensate from step b) can be subjected to hydrotreatment forming a hydrotreated condensate, thus reducing the organic oxygen content of the bio-oil and allowing an easier separation of the bio-oil from the water. The bio-oil can then be separated from the water in the hydrotreated condensate, such as by gravity separation. However, the separation of the bio oil from the hydrotreated condensate can be by any method capable of separating bio-oil from an aqueous phase, and can include, but is not limited to, centrifugation, membrane separation, gravity separation, and the like. The bio-oil can then be further hydrotreated as described in step c).

When the heat transfer media comprises a catalyst, the bio-oil can have a total organic oxygen content of less than about 25, or less than about 15 wt. %, and can generally be separated from the water in the condensate by gravity separation following step b) without any need for hydrotreatment of the condensate. However, the separation of the bio-oil from the condensate can be by any method capable of separating bio-oil from an aqueous phase, and can include, but is not limited to, centrifugation, membrane separation, gravity separation, and the like. The thus separated bio-oil can then be hydrotreated as described in step c).

The conversion reactor effluent can also include unreacted biomass, coke, or char. The condensate from the vapor conversion products comprises, consists of, or consists essentially of bio-oil and water. The conversion reactor can be operated at a temperature in the range of from about 200° C. to about 1000° C., or between about 250° C. and about 800° C. The conversion reactor can also be operated in the substantial absence of oxygen.

The total liquid product can be separated in step e) using a method selected from the group consisting of: atmospheric distillation, vacuum distillation, adsorption, size selective membrane separation, separation using a liquid extraction unit, separation using a high pressure separator, separation using a low pressure separator, and combinations thereof.

The bio oil-derived residue composition can comprise at least about 70, or at least about 75, or at least about 80 wt. % aromatic hydrocarbons, wherein the aromatic hydrocarbons consist primarily of polycyclic aromatic compounds. In accordance with an embodiment, the bio oil-derived residue composition can also comprise less than about 2.5, or less than about 2.7 or less than about 3.0 wt. % of the polycyclic aromatic compounds containing at least 4 rings. Further, at least about 99% of the polycyclic aromatic compounds of the bio oil-derived residue composition can have from 3 to 7 rings. Further, at least about 2.5, or at least about 2.7, or at least about 3 wt. % of the polycyclic aromatic compounds can each have from 4 to 7 rings; and either 0 or 1 ring of each of the polycyclic aromatic compounds can be hydrogenated.

In accordance with another embodiment, less than about 20, or less than about 19, or less than about 18 wt % of the polycyclic aromatic compounds in the bio oil-derived residue composition have 3 rings and at least 18 carbons per molecule. The polycyclic aromatic compounds having 3 rings and at least 18 carbons per molecule can be selected from the group consisting of anthracenes, phenanthrenes, and mixtures thereof.

In accordance with another embodiment, the polycyclic aromatic compounds having at least 4 rings can comprise substitutable carbons, and at least about 50% of the substitutable carbons can be substituted with an alkyl group selected from the group consisting of methyl, ethyl, propyl, butyl, and combinations thereof.

In accordance with an embodiment, the polycyclic aromatic compounds of the bio oil-derived residue composition can comprise bay-region-containing polycyclic aromatic compounds. The bay-region-containing polycyclic aromatic compounds can be selected from the group consisting of alkyl-substituted: phenanthrene, chrysene, benzo(a)pyrene, dibenzo(a,e)pyrene, dibenzo(a,h)pyrene, dibenzo(a,l)pyrene, dibenz(a,h)anthracene, perylene, benzo(ghi)perylene, tetraphene, pentaphene, higher cata-condensed homologues thereof, and combinations thereof.

Further, less than about 1 wt. % of the polycyclic aromatic compounds can comprise an unsubstituted bay region which can form a bay region diol epoxide. Also, at least about 70% of the bay regions of the bay-region-containing polycyclic aromatic compounds can be substituted with an alkyl group. The alkyl group can be selected from the group consisting of methyl, ethyl, propyl, butyl, and combinations thereof.

In accordance with an embodiment, the bio oil-derived residue composition can have a mutagenicity index (MI), as measured by the Modified Ames Test (ASTM E1687), of less than about 3.0, or less than about 2.7, or less than about 2.5. Also, the bio oil-derived residue composition can have a dimethyl sulfoxide extract weight, as measured by IP 346, of less than about 3 weight %. In accordance with the IP 346 test method, the dimethyl sulfoxide extract weight is representative of, and equates to, the weight of polycyclic aromatic compounds.

In accordance with another embodiment, a tire compound can comprise, consist of, or consist essentially of:
i) the bio oil-derived residue composition as described herein;
ii) a polymer; and
iii) a filler.

The polymer can be selected from the group consisting of styrene-butadiene resin, ethylene propylene diene monomer, butyl rubber, and combinations thereof; and the filler can be selected from the group consisting of carbon black, silica, and combinations thereof.

The use of the bio oil-derived residue composition of the presently disclosed and claimed inventive concepts has the advantage of providing excellent solvency, just as that for petroleum-derived DAE's, but without the negative carcinogenic effect.

### Examples

A feedstock of southern yellow pine wood chips was converted in a riser reactor of a continuous fluidized biomass catalytic conversion unit in the presence of an aluminosilicate-containing catalyst. The outlet temperature of the riser reactor was around 1000° F. After cooling and removal of solids and non-condensable gases from the reactor effluent, a free water byproduct was separated from the bio oil by gravity separation. The bio oil was then hydrotreated in a hydrotreating unit containing a Co/Mo catalyst. A fraction boiling at 650 F and above was then separated from the hydrotreated total liquid product by atmospheric distillation, forming a bio oil-derived residue. A sample of the bio oil-derived residue was then subjected to analysis by Gas Chromatography/Mass Spectrometry, and the results of such are shown in Table 1 below.

TABLE 1

| Component | Weight % |
|---|---|
| Paraffins | 1.91 |
| Cycloparaffins | 9.16 |
| Mono-Aromatics | 23.49 |
| Di-Aromatics | 45.14 |
| Tri-Aromatics | 17.87 |
| Tetra-Aromatics | 2.39 |
| Penta-Aromatics | 0.04 |
| Total | 100 |

As shown in Table 1, the bio oil-derived residue contained 88.93 wt. % polycyclic aromatic compounds. Also, of the 45.14 wt. % Di-Aromatics, 10.16 wt. % were 3-ring hydrocarbons having one saturated ring and two aromatic rings. Also, of the 17.87 wt. % Tri-Aromatics, 12.22 wt. % were 3-ring hydrocarbons wherein all three rings were aromatic. Thus, the bio oil-derived residue contained 22.38 wt. % of 3-ring hydrocarbons (including both fully aromatic and partially saturated). Given that mutagenicity arises from PAC containing bay regions, only the fully aromatic 3-ring hydrocarbons of the bio oil-derived residue can contribute to mutagenicity. In order to evaluate the worst case for mutagenicity from the aromatic 3-ring hydrocarbons, it was assumed that all of the 12.22 wt. % of fully aromatic 3-ring hydrocarbons were either substituted or unsubstituted phenanthrenes, which include bay regions, as opposed to anthracenes, which do not have a bay region. Table 2 below shows a breakdown of the fully aromatic 3-ring hydrocarbons by carbon number ranging from 14 to 40, the probability of substituted and unsubstituted phenanthrene toxicity (that is, having an unhindered bay region) for such carbon numbers, and the maximum wt. % of toxic substituted and unsubstituted phenanthrenes. As can be seen in Table 2, even assuming all of the fully aromatic 3-ring hydrocarbons are phenanthrenes and not anthracenes, the maximum amount of toxic phenanthrenes (containing an unhindered bay region) is only 0.16%.

TABLE 2

| Carbon | Phenanthrene | Wt. % | Max Content |
|---|---|---|---|
| # | (Probability of Toxicity) | Phenanthrenes | (wt. %) |
| 14 | 1.00 | 0.00 | 0.00 |
| 15 | 0.80 | 0.00 | 0.00 |
| 16 | 0.56 | 0.00 | 0.00 |
| 17 | 0.34 | 0.02 | 0.01 |
| 18 | 0.17 | 0.47 | 0.08 |
| 19 | 0.07 | 0.75 | 0.05 |
| 20 | 0.02 | 0.98 | 0.02 |
| 21 | 0.00 | 1.35 | 0.00 |
| 22 | 0.00 | 1.36 | 0.00 |
| 23 | 0.00 | 1.11 | 0.00 |
| 24 | 0.00 | 0.90 | 0.00 |
| 25 | 0.00 | 0.74 | 0.00 |
| 26 | 0.00 | 0.65 | 0.00 |
| 27 | 0.00 | 0.63 | 0.00 |
| 28 | 0.00 | 0.59 | 0.00 |
| 29 | 0.00 | 0.48 | 0.00 |
| 30 | 0.00 | 0.47 | 0.00 |
| 31 | 0.00 | 0.41 | 0.00 |
| 32 | 0.00 | 0.36 | 0.00 |
| 33 | 0.00 | 0.30 | 0.00 |
| 34 | 0.00 | 0.23 | 0.00 |
| 35 | 0.00 | 0.17 | 0.00 |
| 36 | 0.00 | 0.11 | 0.00 |
| 37 | 0.00 | 0.08 | 0.00 |
| 38 | 0.00 | 0.04 | 0.00 |
| 39 | 0.00 | 0.02 | 0.00 |
| 40 | 0.00 | 0.00 | 0.00 |
| | Total: | 12.22 | 0.16 |

### IP 346 Testing—Quantification of PAC Content

A sample of the bio oil-derived residue was subjected to testing per IP 346 for isolation and quantification of polycyclic aromatic compounds using the method described below:

1. Equilibrated dimethyl sulfoxide (DMSO) was prepared by combining 1-L of DMSO with 100 ml cyclohexane, shaking, and draining the equilibrated DMSO into an amber bottle.

2. A 4.065 g quantity of the bio oil-derived residue was weighed out and transferred to a first separatory funnel after mixing with 45 ml cyclohexane forming a first mixture.

3. A 100 ml quantity of the DMSO was added to the first separatory funnel and the first mixture was extracted for 1 minute, and the resulting DMSO layer was removed from the first separatory funnel and collected in a second separatory funnel.

4. Step 3 was repeated, with the resulting DMSO layer collected into the second separatory funnel.

5. The contents of the second separatory funnel was diluted with 400 mL of a 4% sodium chloride solution and back extracted for 2 minutes into 40 mL of cyclohexane. The lower layer of the second separatory funnel was collected in a third separatory funnel, and the cyclohexane layer was collected in a fourth separatory funnel. The second separatory funnel was rinsed with cyclohexane with the rinsings added to the fourth separatory funnel. The second separatory funnel was then rinsed with distilled water with the rinsings added to the third separatory funnel.

6. A 40 mL quantity of cyclohexane was added to the third separatory funnel with extraction for 2 minutes. The resulting upper layer was added to the fourth separatory funnel. The third separatory funnel was rinsed with cyclohexane with the rinsings added to the fourth separatory funnel.

7. The combined cyclohexane layers contained in the fourth separatory funnel were washed with 25 mL of warmed sodium chloride solution for 1 minute. The resulting aqueous layer was removed from the fourth separatory funnel.

8. Step 7 was repeated.

9. The resulting cyclohexane solution in the fourth separatory funnel was then filtered through a funnel containing folded filter paper and 5 g anhydrous sodium sulfate. The filter paper was then washed with cyclohexane with the extract and rinsings collected in a flask.

10. The extract and rinsings were then subjected to evaporation in a rotary vacuum evaporator at approximately 50° C. until solvent was removed, then evaporated at 80° C. for 1 hour.

11. The sample was then allowed to cool and was weighed.

The weight of the sample, which was extracted with dimethyl sulfoxide, equates to the weight of PAC's in accordance with this IP 346 test. The sample weighed 0.0844 g; and, thus, the wt % PAC's in the bio oil-derived residue was measured to be:

100*(0.0844/4.065)=2.08% (˜2.1%); which is well below the 3 wt. % value, above which requires labeling as carcinogenic by the European Commission.
Mutagenicity Index measurement—Modified Ames Test (ASTM E1687)

Two different samples of the bio oil-derived residue, produced as described above, were subjected to the Modified Ames Test per ASTM method E 1687 to determine the Mutagenicity Index value. The Mutagenicity Index was measured to be 2.1 for the first sample and 2.3 for the second sample. This compares favorably to the Mutagenicity Index for petroleum-derived DAE's which are typically greater than 3. Such DAE's have higher concentrations of 4-7 ring PAC, and much less ring alkylation, as compared to the bio oil-derived residue composition described herein.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

Further, unless expressly stated otherwise, the term “about” as used herein is intended to include and take into account variations due to manufacturing tolerances and/or variabilities in process control.

Changes may be made in the construction and the operation of the various components, elements and assemblies described herein, and changes may be made in the steps or sequence of steps of the methods described herein without departing from the spirit and the scope of the invention as defined in the following claims.

What is claimed is:

1. A bio oil-derived residue composition having an initial boiling point of at least about 650° F., and comprising at least about 70 wt. % aromatic hydrocarbons, wherein the aromatic hydrocarbons comprise polycyclic aromatic compounds, and wherein the bio oil-derived residue composition comprises less than about 3 wt. % of the polycyclic aromatic compounds containing at least 4 rings.

2. The bio oil-derived residue composition of claim 1 comprising less than about 20 wt % of the polycyclic aromatic compounds having 3 rings and at least 18 carbons per molecule.

3. The bio oil-derived residue composition of claim 2 where the polycyclic aromatic compounds having 3 rings and at least 18 carbons per molecule are selected from the group consisting of anthracenes, phenanthrenes, and mixtures thereof.

4. The bio oil-derived residue composition of claim 1 wherein the polycyclic aromatic compounds having at least 4 rings comprise substitutable carbons, and wherein at least about 50% of the substitutable carbons are substituted with an alkyl group selected from the group consisting of methyl, ethyl, propyl, butyl, and combinations thereof.

5. The bio oil-derived residue composition of claim 1 wherein less than about 1 wt. % of the polycyclic aromatic compounds comprise an unsubstituted bay region which can form a bay region diol epoxide.

6. The bio oil-derived residue composition of claim 1 wherein the polycyclic aromatic compounds comprise bay-region-containing polycyclic aromatic compounds.

7. The bio oil-derived residue composition of claim 6 wherein the bay-region-containing polycyclic aromatic compounds are selected from the group consisting of alkyl-substituted: phenanthrene, chrysene, benzo(a)pyrene, dibenzo(a,e)pyrene, dibenzo(a,h)pyrene, dibenzo(a,l)pyrene, dibenz(a,h)anthracene, perylene, benzo(ghi)perylene, tetraphene, pentaphene, higher cata-condensed homologues thereof, and combinations thereof.

8. The bio oil-derived residue composition of claim 6 wherein at least about 70% of the bay regions of the bay-region-containing polycyclic aromatic compounds are substituted with an alkyl group.

9. The bio oil-derived residue composition of claim 8 wherein the alkyl group is selected from the group consisting of methyl, ethyl, propyl, butyl, and combinations thereof.

10. The bio oil-derived residue composition of claim 1 having a mutagenicity index (MI), as measured by the Modified Ames Test (ASTM E1687), of less than about 3.0.

11. The bio oil-derived residue composition of claim 1 having a dimethyl sulfoxide extract weight, as measured by IP346, of less than about 3 weight %.

12. The bio oil-derived residue composition of claim 1 wherein at least about 99% of the polycyclic aromatic compounds have from 3 to 7 rings.

13. The bio oil-derived residue composition of claim 1 wherein at least about 3 wt. % of the polycyclic aromatic compounds each have from 4 to 7 rings and wherein either 0 or 1 ring of each of the polycyclic aromatic compounds is hydrogenated.

14. The bio oil-derived residue composition of claim 1, wherein the bio oil-derived residue composition is prepared by a process comprising:
a) converting biomass in a conversion reactor containing a heat transfer media to thereby produce a conversion reactor effluent comprising vapor conversion products;
b) condensing at least a portion of the vapor conversion products to produce a condensate comprising bio-oil and water, wherein the bio-oil has a total organic oxygen content of less than about 40 wt. %;
c) hydrotreating the bio-oil with hydrogen in a hydrotreater reactor to produce a hydrotreater reactor effluent;
d) separating a total liquid product having less than about 3 wt % organic oxygen from the hydrotreater reactor effluent, and
e) separating the bio oil-derived residue composition from the total liquid product.

15. The bio oil-derived residue composition of claim 14 wherein the condensate is subjected to hydrotreatment forming a hydrotreated condensate and the bio-oil is separated from the water in the hydrotreated condensate prior to step c).

16. The bio oil-derived residue composition of claim 14 wherein the heat transfer media comprises a catalyst, the bio-oil has a total organic oxygen content of less than about 25 wt. %, and the bio-oil is separated from the water in the condensate prior to step c).

17. The bio oil-derived residue composition of claim 14 wherein the total liquid product is separated in step e) using atmospheric distillation.

18. The bio oil-derived residue composition of claim 14 wherein the total liquid product is separated in step e) using vacuum distillation.

19. The bio oil-derived residue composition of claim 14 wherein the total liquid product is separated in step e) using adsorption.

20. The bio oil-derived residue composition of claim 14 wherein the total liquid product is separated in step e) using a size selective membrane.

21. The bio oil-derived residue composition of claim 14 wherein the total liquid product is separated in step e) using a liquid extraction unit.

22. A tire compound comprising:
i) a bio oil-derived residue composition having an initial boiling point of at least about 650° F., and comprising at least about 70 wt. % aromatic hydrocarbons, wherein the aromatic hydrocarbons comprise polycyclic aromatic compounds, and wherein the bio oil-derived residue composition comprises less than about 3 wt. % of the polycyclic aromatic compounds containing at least 4 rings;
ii) a polymer; and
iii) a filler.

23. The tire compound of claim 22 wherein the polymer is selected from the group consisting of styrene-butadiene resin, ethylene propylene diene monomer, butyl rubber, and combinations thereof.

24. The tire compound of claim 22 wherein the filler is selected from the group consisting of carbon black, silica, and combinations thereof.

25. A process for producing a bio oil-derived residue composition comprising:
a) converting biomass in a conversion reactor containing a heat transfer media to thereby produce a conversion reactor effluent comprising vapor conversion products;
b) condensing at least a portion of the vapor conversion products to produce a condensate comprising bio oil and water, wherein the bio-oil has a total organic oxygen content of less than about 40 wt. %;
c) hydrotreating the bio-oil with hydrogen in a hydrotreater reactor to produce a hydrotreater reactor effluent;
d) separating a total liquid product from the hydrotreater reactor effluent, and
e) separating the bio oil-derived residue composition from the total liquid product, wherein the bio oil-derived residue composition has an initial boiling point of at least about 650° F., and comprises at least about 70 wt. % aromatic hydrocarbons, wherein the aromatic hydrocarbons comprise polycyclic aromatic compounds, and wherein the bio oil-derived residue composition comprises less than about 3 wt. % of the polycyclic aromatic compounds containing at least 4 rings.

26. The process of claim 25 wherein the condensate is subjected to hydrotreatment forming a hydrotreated condensate and the bio-oil is separated from the water in the hydrotreated condensate prior to step c).

27. The process of claim 25 wherein the heat transfer media comprises a catalyst, the bio-oil has a total organic oxygen content of less than about 25 wt. %, and the bio-oil is separated from the water in the condensate prior to step c).

28. The process of claim 25 wherein the bio oil-derived residue composition comprises less than about 20 wt % of the polycyclic aromatic compounds having 3 rings and at least 18 carbons per molecule.

29. The process of claim 28 where the polycyclic aromatic compounds having 3 rings and at least 18 carbons per molecule are selected from the group consisting of anthracenes, phenanthrenes, and mixtures thereof.

30. The process of claim 25 wherein the polycyclic aromatic compounds having at least 4 rings comprise substitutable carbons, and wherein at least about 50% of the substitutable carbons are substituted with an alkyl group selected from the group consisting of methyl, ethyl, propyl, butyl, and combinations thereof.

31. The process of claim 25 wherein less than about 1 wt. % of the polycyclic aromatic compounds comprise an unsubstituted bay region which can form a bay region diol epoxide.

32. The process of claim 25 wherein the polycyclic aromatic compounds comprise bay-region-containing polycyclic aromatic compounds.

33. The bio oil-derived residue composition of claim 32 wherein the bay-region-containing polycyclic aromatic compounds are selected from the group consisting of alkyl-substituted: phenanthrene, chrysene, benzo(a)pyrene, dibenzo(a,e)pyrene, dibenzo(a,h)pyrene, dibenzo(a,l)pyrene, dibenz(a,h)anthracene, perylene, benzo(ghi)perylene, tetraphene, pentaphene, higher cata-condensed homologues thereof, and combinations thereof.

34. The process of claim 32 wherein at least about 70% of the bay regions of the bay-region-containing polycyclic aromatic compounds are substituted with an alkyl group.

35. The process of claim 25 wherein the bio oil-derived residue composition has a mutagenicity index (MI), as measured by the Modified Ames Test (ASTM E1687), of less than about 3.0.

36. The process of claim 25 wherein the bio oil-derived residue composition has a dimethyl sulfoxide extract weight, as measured by IP346, of less than about 3 wt. %.

37. The process of claim 25 wherein at least about 99 wt. % of the polycyclic aromatic compounds each have from 3 to 7 rings.

38. The process of claim 25 wherein at least about 3 wt. % of the polycyclic aromatic compounds each have from 4 to 7 rings and wherein either 0 or 1 ring of each of the polycyclic aromatic compounds is hydrogenated.
